(19) United States
(12) Patent Application Publication
(10) Pub. No.: US 2017/0028338 A1
(43) Pub. Date: Feb. 2, 2017

(54) AIR FILTER

(71) Applicant: 3M INNOVATIVE PROPERTIES COMPANY, St. Paul, MN (US)

(72) Inventors: Liming Xin, Shanghai (CN); Andrew R. Fox, Oakdale, MN (US); Liang Cheng, Shanghai (CN); Changwen Li, Shanghai (CN); Rui Chen, Shanghai (CN)

(21) Appl. No.: 15/113,321

(22) PCT Filed: Jan. 22, 2015
(86) PCT No.: PCT/US15/12334

§ 371 Date: Jul. 21, 2016

(30) Foreign Application Priority Data
Jan. 22, 2014 (CN) 201420042045.0

(51) Int. Cl. B01D 46/52; F24F 13/28; B01D 46/00

(52) U.S. Cl. CPC B01D 46/521; B01D 46/0001; F24F 13/28; B01D 2265/04; B01D 2265/028; B01D 2279/50

(57) ABSTRACT

Some embodiments of the present disclosure relate to improving or overcoming at least one problem in existing air filters by including at least one folding structure in or on the air filter. The folding structure is capable of being bent to enable the air filter to be wrapped around or secured to a, for example, washing net. The folding structure can also hold the air filter securely to the, for example, washing net.

### TECHNICAL FIELD

The present disclosure relates generally to air filters. In some embodiments, the air filter is used in air conditioners, air filters, or air flow devices. In some embodiments, the air filters are used in domestic air conditioners.

### BACKGROUND

Air pollution has become a global problem. Especially in places like China, air quality is and will continue to be a long-term issue. As people's living standard improves, people desire higher air quality. To remove indoor air pollutants, a washing net is commonly arranged in the indoor unit of an air conditioner. The washing net of some air conditioners is provided with a small coarse mesh filter. However, the pores of the washing net are large and thus mainly filter large-size dust and hairs. Consequently, the filtering effect is poor. The small coarse mesh filter also has poor filtering effect due to small filtration size. Additionally, the small coarse mesh filter cannot be applied to different types of air conditioners.

Patent CN95220079.1 discloses a solution having two layers of static polypropylene melt-blown non-woven fabric folded to form a zigzag shape and then fixed on a grid frame made of plastic.

Patent CN99217807.X discloses an air filter for air conditioners including (1) a highly breathable air filter as a pre-positioned air filter layer outside; (2) a breathable air filter composed of a photocatalyst and a small amount of active carbon as an intermediate layer; and (3) an efficient static air filter as an inner layer. The preceding layers are overlapped/layered in the sequence described above and are framed or gummed on four sides for fixation. The resulting apparatus is applied to the air conditioner or the air filter in an air inlet and outlet pipeline of an air supply device by insertion or adhesion.

### BRIEF SUMMARY

The inventors of the present disclosure recognized some problems or disadvantages of the prior art solutions described above. For example, although the adsorption and filtration capability is improved, the technical scheme described in Patent CN99217807.X undesirably increases the wind resistance. the air filter may not meet the space requirement in the air conditioner or the air inlet and outlet pipeline of the air supply device. Also, the air filter may not fit with the air conditioner or the air supply device well, thus negatively affecting the working efficiency of the air conditioner.

The present disclosure can improve or overcome at least one problem in the prior art by including at least one folding structure in the air filter. The folding structure is capable of being bent to enable the air filter to be wrapped around or secured to a, for example, washing net. The folding structure can also hold the air filter securely to the, for example, washing net. In some embodiments, the folding structure is capable of bending not only itself but the relevant portion of the air filter to an angle of at least 30 degrees. In some embodiments, the folding structure is capable of bending not only itself but the relevant portion of the air filter to an angle of at least 60 degrees. In some embodiments, the folding structure is capable of bending not only itself but the relevant portion of the air filter to an angle of at least 90 degrees. In some embodiments, the folding structure is capable of bending not only itself but the relevant portion of the air filter to an angle of at least 120 degrees. In some embodiments, the folding structure is capable of bending not only itself but the relevant portion of the air filter to an angle of at least 160 degrees. In some embodiments, the folding structure is capable of bending not only itself but the relevant portion of the air filter to an angle of at least 180 degrees.

The present disclosure relates generally to an air filter, comprising: a filtration media; a support structure; and at least one folding structure that permits folding of the filtration media and the support structure. In some embodiments, the folding structure is fold line. In some embodiments, the folding structure is one or more bendable devices in or on the air filter.

Some embodiments of the present disclosure relate to a method of forming an air filter including filtration media adjacent to a support structure, comprising forming or including a folding structure in or on the air filter. In some embodiments, the folding structure is fold line. In some embodiments, forming the fold line involves pre-pressing, embossing, creasing, indenting, hot bonding, and/or ultrasonic welding. In some embodiments, the folding structure is one or more bendable devices in or on the air filter.

Some embodiments include multiple folding structures. In some embodiments, the folding structures extend along the x-axis. In some embodiments, the folding structures extend along the y-axis. In some embodiments, the folding structures extend along both the x-axis and the y-axis. In some embodiments, the folding structure(s) is parallel to an edge of the air filter media.

Some embodiments include a region defined by a fold line and a first edge of the filtration media comprises a connecting structure. In some embodiments, the connecting structure comprises at least one continuous adhesive tape and/or sticky hook. In some embodiments, the connecting structure comprises at least two discontinuous adhesive tapes and/or sticky hooks.

In some embodiments, the support structure is capable of reinforcing the filtration media to provide smoothness of the whole air filter and/or to minimize wrinkling of the air filter during installation and use. In some embodiments, the support structure is a grid. In some embodiments, the support structure is combined with the surface of the filtration media. In some embodiments, the support structure comprises an ultrasonic line formed on the surface of the filtration media by ultrasonic welding.

In some embodiments, the filtration media is a static-loaded non-woven material.

In some embodiments, the air filter includes a washing net covered by the filtration media. In some embodiments, the coverage rate is 60% to 85%. In some embodiments, the coverage rate is 68% to 83%.

In some embodiments, the air filter is capable of enabling the filtration media to be bent easily and fixed onto the washing net, which is convenient for installation of the air filter.

In some embodiments, the air filter is held in place by a bendable metallic clip on the filtration media. In some embodiments, the metallic clip comprises two bendable metallic clips in parallel or one integrated bendable metallic clip.

In some embodiments, the air filter provides convenient installation with minimal to no effect on the fan speed of the air conditioner.

### BRIEF DESCRIPTION OF THE FIGURES

The present application may be more completely understood in consideration of the following detailed description of various embodiments of the disclosure in connection with the accompanying drawings. The following figures describe some exemplary constructions of various embodiments of the air filter use indicators described in the present disclosure. These figures describe some exemplary constructions and methods of using these various embodiments. The following figures are intended to be illustrative, but are not intended to limit the scope of the present disclosure.

FIG. 1 is a schematic diagram of an exemplary first embodiment of an air filter corresponding to the teachings of the present disclosure.

FIG. 2 is a schematic drawing showing an exemplary method of installing the air filter of FIG. 1.

FIG. 3 is a schematic diagram of an exemplary second embodiment of an air filter corresponding to the teachings of the present disclosure.

FIG. 4 is a schematic drawing showing an exemplary method of installing the air filter of FIG. 3.

FIG. 5 is a schematic diagram of an exemplary third embodiment of an air filter corresponding to the teachings of the present disclosure.

FIG. 6 is a schematic diagram of an exemplary fourth embodiment of an air filter corresponding to the teachings of the present disclosure.

FIG. 7 is a schematic diagram of an exemplary fifth embodiment of an air filter corresponding to the teachings of the present disclosure.

FIG. 8 is a schematic diagram of an exemplary sixth embodiment of an air filter corresponding to the teachings of the present disclosure.

FIG. 9 is a schematic diagram of an exemplary seventh embodiment of an air filter corresponding to the teachings of the present disclosure.

FIG. 10 is a performance test chart for an exemplary air filter corresponding to the teachings provided in the present disclosure.

### DETAILED DESCRIPTION OF EXEMPLARY EMBODIMENTS

Various embodiments and implementations will be described in detail. These embodiments should not be construed as limiting the scope of the present disclosure in any manner, and changes and modifications may be made without departing from the spirit and scope of the inventions described herein. Further, only some end uses have been discussed herein, but end uses not specifically described herein are included within the scope of the present disclosure. As such, the scope of the present disclosure should be determined only by the claims.

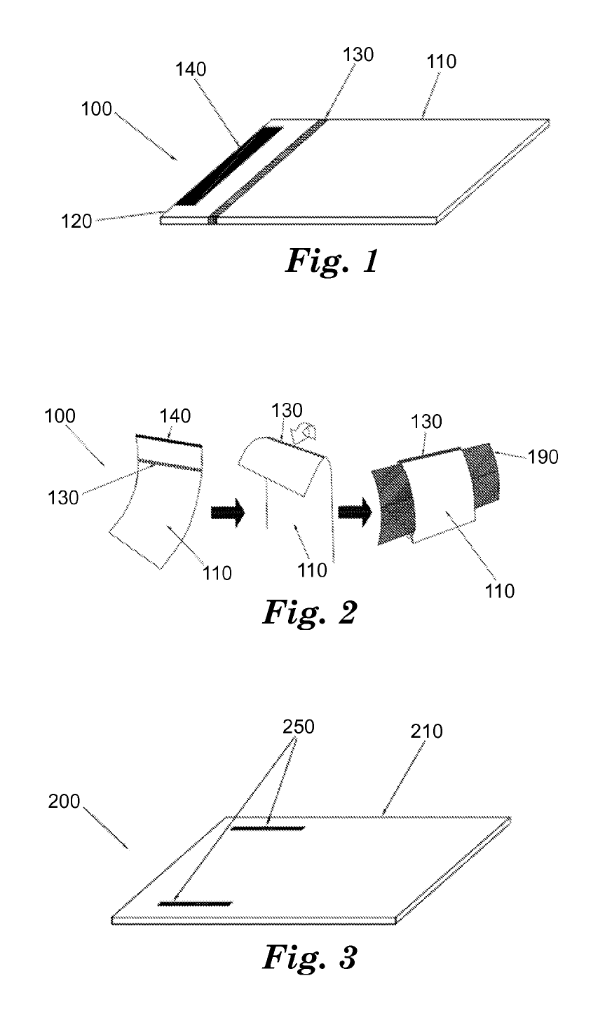

In FIG. 1, an air filter 100 comprises air filter media 110 and a fold line 130, wherein the fold line 130 is parallel to a first edge 120 of air filter media 110. Connecting structure 140 the region of air filter media 110 that is between the fold line 130 and the first edge 120. In some embodiments, the fold line 130 can be formed on the surface of the air filter media by creasing, indenting, embossing, hot bonding, or ultrasonic welding. In some embodiments (not shown), connecting structure 140 can include or comprise a continuous adhesive tape or sticky hook, or two continuous adhesive tape or (and) sticky hooks, and/or a plurality of discontinuous adhesive tapes or (and) sticky hooks.

In the exemplary method schematically shown in FIG. 2, installation of air filter 100 includes the following steps: (1) folding the air filter media 110 along the fold line 130, (2) covering at least a portion of a washing net 190 with filter material 110, and (3) using connecting structure 140 to ensure that the air filter media 110 and the washing net 190 are held together with minimal sliding or moving during operation or use.

In FIG. 3, an air filter 200 includes two bendable metallic clips 250 that are arranged in parallel on air filter media 210. In some embodiments, the metallic clips 250 keep the original shape after being bent.

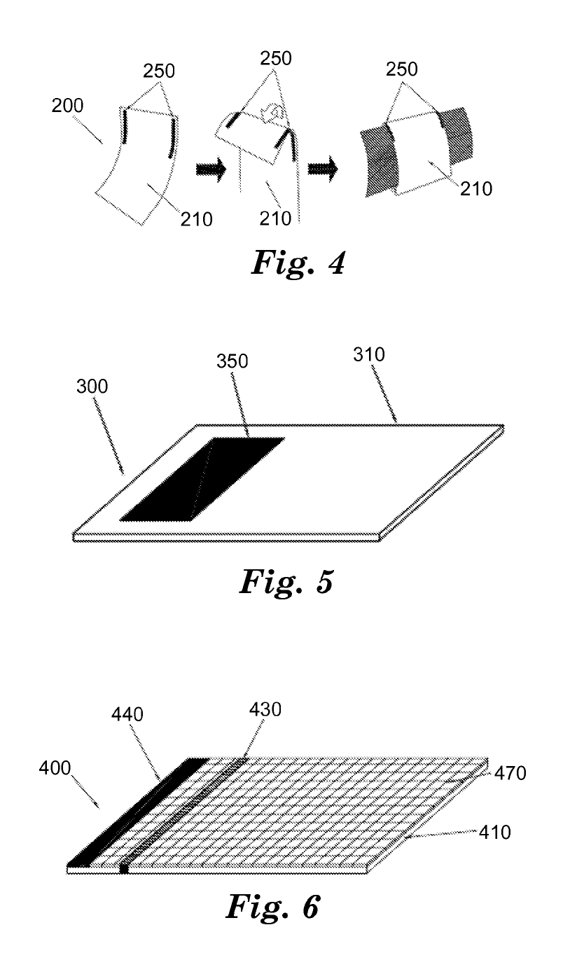

In the exemplary method shown schematically in FIG. 4, the installation of the air filter 200 includes the following steps: (1) bending metallic clips 250, (2) covering at least a portion of a washing net 290 with filter material 210 and (3) keeping the metallic clips 250 in a bent state to ensure that the air filter media 210 and the washing net 290 are held together with minimal sliding or moving during operation or use.

In FIG. 5, an air filter 300 is provided with an integrated metallic clip 350 on the air filter media 310. The installation method provided by Embodiment 2 is applicable to this type of embodiment.

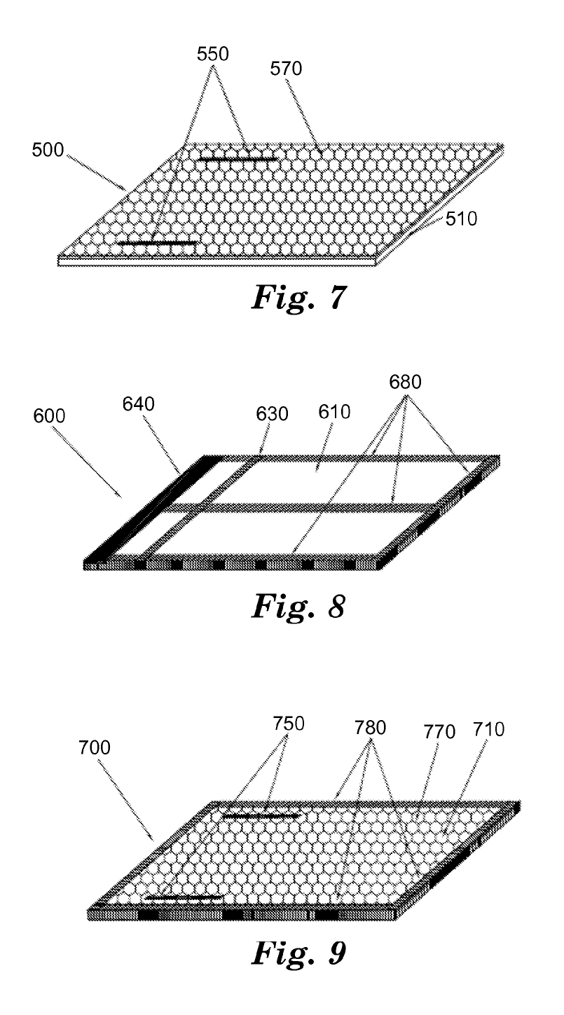

FIG. 6 and FIG. 7 show embodiments in which the air filter or air filter media includes a grid 470 (or 570 in FIG. 5) on the surface of air filter media 410 (or 510 of FIG. 5) to reinforce the air filter media 410 (or 510 of FIG. 5), thus improving the smoothness of the air filter 400 (or 500 of FIG. 5).

In some embodiments, the grid can be a plastic grid 470, an active carbon grid 580, and/or a functional grid such as a grid with absorbent, a grid with activator, or a grid with absorbent and activator. Grids can be used in any embodiments shown or described herein and is not limited to the specific embodiments shown in FIG. 6 or 7. The grid can have any desired shape, thickness, pattern, repeating unit, etc.

FIGS. 8 and 9 show air filters 600 and 700 including an ultrasonic line 680 (or 780) on the surface of the air filter media 610 (or 710) by, for example, ultrasonic welding. In some embodiments, the ultrasonic line 680 is formed around the air filter media 610 and perpendicularly to the central line of the fold line 630 by ultrasonic welding. In some embodiments, the ultrasonic lines improve the smoothness of the air filter 600 (or 700). Ultrasonic lines can be used in any embodiments shown or described herein and is not limited to the specific embodiments shown in FIG. 6 or 7. The ultrasonic lines can have any desired shape, thickness, pattern, repeating unit, spacing, etc.

In some embodiments, static-loaded non-woven fabric is used as the air filter media 110 (or 210, or 310, or 410, or 510, or 610, or 710). Use of this material can assist in achieving high filtration efficiency without affecting the wind resistance. In some embodiments, the air filter media is a layer of at least one of spun-bonded non-woven fabric, melt-blown non-woven fabric, carded non-woven fabric, or air-laid non-woven fabric.

In some embodiments, the air filter media 110 (or 210) incompletely covers the washing net 190 (or 290), and the coverage rate is 60% to 85%. In some embodiments, the coverage rate is 68% to 83%.

In some embodiments, the air filter is used in air conditioners, air filters, or air flow devices. In some embodiments, the air filters are used in domestic air conditioners.

Objects and advantages of the present disclosure are further illustrated by the following examples, but the particular materials and amounts thereof recited in the examples, as well as other conditions and details, should not be construed to unduly limit the scope of the application, as those of skill in the art will recognize that other parameters, materials, and equipment may be used. All parts, percentages and ratios herein are by weight unless otherwise specified.

### EXAMPLES

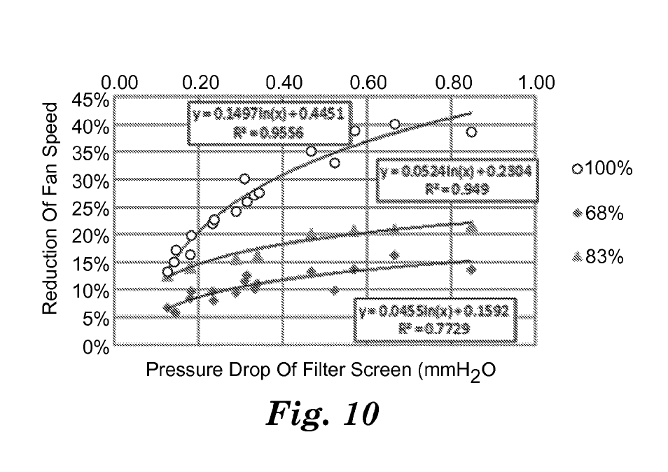

To verify the influence of the coverage rate on the fan speed of air conditioners, a test was conducted using a split-type air conditioner GWH12KF-D3DNB1C/I manufactured by GREE. The GREE air conditioner was provided with two plastic washing nets having the same size at an inlet end of a cooling coil, and the size of each washing net was 27.3 cm×29.8 cm. Seventeen non-woven fabric filter material samples made of different materials were evaluated for their influence on the fan speed of the GREE air conditioner. Three different air filter coverage levels were tested for each of the seventeen non-woven fabric filter material samples: 100%, 68%, and 83%. With respect to the tests conducted with 68% coverage, the washing was wrapped with the air filter leaving a distance of 2.54 cm between each edge of the filter material sample and the edge of the washing net to realize a coverage rate of 68%. With respect to the tests conducted with 83% coverage, the washing was wrapped with the air filter leaving a distance of 2.54 cm between each edge of the filter material sample and the edge of the washing net to realize a coverage rate of 83%. The pressure drop of the air filter in the presence of each of the samples was tested at an airflow of 14 cm/s. The results are shown in FIG. 10 where the pressure drop was recorded in mm of H₂O.

The test results above show that, for example, the fan speed of the air conditioner is liable to be reduced (by 25% or more) where the air filter media completely covers the washing net. In instances where the coverage rate of the air filter media on the washing net is 68% or 83%, the maximum filtration effect is available without negatively affecting the fan speed of the air conditioner.

The recitation of all numerical ranges by endpoint is meant to include all numbers subsumed within the range (i.e., the range 1 to 10 includes, for example, 1, 1.5, 3.33, and 10).

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims.

1. An air filter, comprising:
a filtration media;
a support structure; and
at least one folding structure that permits folding of the filtration media and the support structure.

2. The air filter of claim 1, wherein the folding structure is fold line.

3. The air filter of claim 1, wherein the folding structure is one or more bendable devices in or on the air filter.

4. The air filter of any of the preceding claims, further comprising multiple folding structures.

5. The air filter of any of the preceding claims, wherein the folding structure extends along the x-axis.

6. The air filter of any of the preceding claims, wherein the folding structure extends along the y-axis.

7. The air filter of any of the preceding claims, wherein the folding structure extends along both the x-axis and the y-axis.

8. The air filter of any of the preceding claims, wherein the folding structure is parallel to an edge of the air filter media.

9. The air filter of any of the preceding claims, including a connecting structure.

10. The air filter of claim 9, wherein the connecting structure is located between a fold line and a first edge of the filter media.

11. The air filter of claim 9 or claim 10, wherein the connecting structure comprises at least herein the connecting structure comprises at least one continuous adhesive tape and/or sticky hook.

12. The air filter of any of claims 9-11, wherein the connecting structure comprises at least two discontinuous adhesive tapes and/or sticky hooks.

13. The air filter of any of the preceding claims, wherein the support structure is capable of reinforcing the filtration media to provide smoothness of the whole air filter and/or to minimize wrinkling of the air filter during installation and use.

14. The air filter of any of the preceding claims, wherein the support structure is a grid.

15. The air filter of any of the preceding claims, wherein the support structure is combined with the surface of the filtration media.

16. The air filter of any of the preceding claims, wherein the support structure comprises an ultrasonic line formed on the surface of the filtration media.

17. The air filter of any of the preceding claims, wherein the filtration media is a static-loaded non-woven material.

18. The air filter of any of the preceding claims, wherein the filtration media is not electrically charged.

19. The air filter of any of the preceding claims, further including a washing net around which the air filter is wrapped.

20. The air filter of any of the preceding claims, wherein the air filter covers between 60% to 85% of the surface area of the washing net.

21. The air filter of any of the preceding claims, wherein the air filter covers between 68% to 83% of the surface area of the washing net.

22. The air filter of any of the preceding claims, further including at least one flexible metal clip capable of securing the air filter to a washing net.

23. The air filter of any of the preceding claims, wherein the air filter is an air conditioner air filter.

24. A method of forming an air filter including filtration media adjacent to a support structure, comprising:
forming or including a folding structure in or on the air filter.

25. The method of claim 24, wherein the folding structure is fold line.

26. The method of claim 25, wherein forming the fold line involves pre-pressing, embossing, creasing, indenting, hot bonding, and/or ultrasonic welding.

27. The method of claim 24, wherein the folding structure is one or more bendable devices in or on the air filter.

28. The method of any of claims 24-27, further comprising multiple folding structures.

29. The method of any of claims 24-28, wherein the folding structure extends along the x-axis.

30. The method of any of claims 24-29, wherein the folding structure extends along the y-axis.

31. The method of any of claims 24-30, wherein the folding structure extends along both the x-axis and the y-axis.

32. The method of any of claims 24-31, wherein the folding structure is parallel to an edge of the air filter media.

33. The method of any of claims 24-32, further including a connecting structure.

34. The method of claim 33, wherein the connecting structure is between a fold line and a first edge of the filter media.

35. The method of claim 33 or 34, wherein the connecting structure comprises at least one continuous adhesive tape and/or sticky hook.

36. The method of any of claims 33-35, wherein the connecting structure comprises at least two discontinuous adhesive tapes and/or sticky hooks.

37. The method of any of claims 24-36, wherein the support structure is capable of reinforcing the filtration media to provide smoothness of the whole air filter and/or to minimize wrinkling of the air filter during installation and use.

38. The method of any of claims 24-37, wherein the support structure is a grid.

39. The method of any of claims 24-38, wherein the support structure is combined with the surface of the filtration media.

40. The method of any of claims 24-39, wherein the support structure comprises an ultrasonic line formed on the surface of the filtration media.

41. The method of any of claims 24-40, wherein the filtration media is a static-loaded non-woven material.

42. The method of any of claims 24-41, wherein the filtration media is not electrically charged.

43. The method of any of claims 24-42, further including a washing net around which the air filter is wrapped.

44. The method of claim 43, wherein the air filter covers between 60% to 85% of the surface area of the washing net.

45. The method of any of claims 24-44, wherein the air filter covers between 68% to 83% of the surface area of the washing net.

46. The method of any of claims 24-45, further including at least one flexible metal clip capable of securing the air filter to a washing net.

47. The method of any of claims 24-46, wherein the air filter is an air conditioner air filter.
